(19) United States
(12) Patent Application Publication
(10) Pub. No.: US 2017/0008762 A1
(43) Pub. Date: Jan. 12, 2017

(54) SYSTEM AND METHOD FOR THE MATERIAL USE OF HYDROGEN

(71) Applicant: HYDROGENIOUS TECHNOLOGIES GMBH, Erlangen (DE)

(72) Inventors: Wolfgang Arlt, Nurnberg (DE); Andreas Bosmann, Hessdorf (DE); Patrick Preuster, Heideck (DE); Peter Wasserscheid, Erlangen (DE)

(21) Appl. No.: 15/113,572

(22) PCT Filed: Jan. 14, 2015
(86) PCT No.: PCT/EP2015/050604

§ 371 Date: Jul. 22, 2016

(30) Foreign Application Priority Data
Jan. 24, 2014 (DE) 10 2014 201 332.1

(51) Int. Cl. C01B 3/00; B01J 19/24; B01J 19/00

(52) U.S. Cl. CPC C01B 3/0015; B01J 19/0006; B01J 19/24; B01J 19/245; B01J 2219/00058; B01J 2219/00162

(57) ABSTRACT

A system for the material use of hydrogen includes a transfer-hydrogenation facility with a transfer-hydrogenation unit for the hydrogenation of a material for hydrogenation and a hydrogen-provision device for the provision of hydrogen for the transfer-hydrogenation facility, where, via the hydrogen-provision device, hydrogen in bound form is provided for the transfer-hydrogenation facility, and the hydrogen-provision device includes a loading unit for the loading of a carrier medium with hydrogen.

### CROSS REFERENCE TO RELATED APPLICATIONS

This application is a United States National Phase Application of International Application PCT/EP2015/050604 filed Jan. 14, 2015 and claims the benefit of priority under 35 U.S.C. §119 of German Application 10 2014 201 332.1 filed Jan. 24, 2014 the entire contents of which are incorporated herein by reference.

### FIELD OF THE INVENTION

The present invention to a system and a method for the material use of hydrogen, especially from liquid organic hydrides.

### BACKGROUND OF THE INVENTION

A material use of hydrogen, for example, through the use of hydrogen as a raw material for a catalytic hydrogenation of organic or inorganic compounds, is of major commercial significance. The material use of hydrogen according to the prior art conventionally requires the handling of molecular hydrogen. The use of molecular gaseous hydrogen is possible only under high pressure. The storage and handling of molecular hydrogen is complicated and associated with safety-technology risks. Minimizing the safety-technology risks requires large expenditure on apparatus and costs associated with this. In particular, the hydrogen compression is an energy-intensive method step which requires especially the use of cost-intensive and maintenance-intensive compressors.

### SUMMARY OF THE INVENTION

The present invention is based on an object of improving the availability of hydrogen for its material use.

This object is achieved by a system for the material use of hydrogen comprising a transfer-hydrogenation facility with a transfer-hydrogenation unit for the hydrogenation of a material for hydrogenation, a hydrogen-provision device for the provision of hydrogen for the transfer-hydrogenation facility, wherein, by means of the hydrogen-provision device, hydrogen is provided in bound form for the transfer-hydrogenation facility, and wherein the hydrogen-provision device comprises a loading unit for loading a carrier medium with hydrogen.

This object is further achieved by a method for the material use of hydrogen comprising the method steps:
loading of a carrier medium with hydrogen by means of a loading unit;
provision of the hydrogen bound to the carrier medium by means of hydrogen-provision device;
hydrogenation of a material for hydrogenation by means of a transfer-hydrogenation unit of a transfer-hydrogenation facility with use of the hydrogen provided in bound form.

A system according to the invention for the material use of hydrogen comprises a transfer-hydrogenation facility with a transfer-hydrogenation unit for the hydrogenation of a material for hydrogenation, such as an unsaturated organic molecule, especially toluene. Material use is understood as the use of hydrogen generally in hydrogenation reactions of the chemical and/or material-converting industry. Such hydrogenation reactions are used for the conversion of organic or inorganic chemical compounds with hydrogen to form compounds of which the hydrogen content is increased by comparison with the starting compound or the starting compounds. In the case of the material use of hydrogen in a hydrogenation reaction, hydrogen is used to increase the hydrogen content of the material for hydrogenation by creating new chemical bonds. For the provision of hydrogen for the transfer-hydrogenation facility, a hydrogen-provision device is provided according to the invention. In particular, provision is made for the provision of a hydrogen-rich compound which has been manufactured, especially from a hydrogen-poor compound through hydrogenation for use in the transfer-hydrogenation facility. By means of the hydrogen-provision device, hydrogen is provided in bound form, especially in chemically bound form, for the transfer-hydrogenation facility. The hydrogen-provision device comprises a loading unit for the loading of a carrier medium with hydrogen. A loading unit of this kind allows the chemical binding of the hydrogen to the carrier medium, especially to LOHC, in an uncomplicated and comparatively inexpensive manner. This form of hydrogen storage has the particular advantage that, under the process conditions used, LOHC carrier media are present as organic compound in liquid form. In particular, the LOHC carrier media mean that they can be loaded with hydrogen, and hydrogen can be unloaded from them in a reversible manner. The physical-chemical properties of the LOHC carrier media have high similarity with conventional liquid fuels, so that pumps and tankers for transport and containers for storage from the fuel and combustibles logistics sector can be used. The hydrogen storage in chemically bound form in an organic liquid allows an unpressurized storage under normal conditions over considerable periods of time without significant loss of hydrogen. In particular, polycyclic, aromatic compounds with one π-electron system or several π-electron systems can be used as LOHC carrier media, which are transferred into the respective saturated polycyclic compounds in a catalytic hydrogenation. In particular, dibenzyl toluenes and benzyl toluenes as pure substances, isomeric mixtures or mixtures of these substances with one another can be used as LOHC carrier media. It is also possible to use as LOHC carrier media polycyclic, heteroaromatic compounds with one π-electron system or several π-electron systems, which are transferred into the respective saturated, polycyclic compounds through hydrogenation in the loading unit, which contain heteroatoms such as nitrogen or oxygen. In particular, N-ethylcarbazole, N-propylcarbazole, N-isopropylcarbazole, N-butylcarbazole or mixtures of these substances with one another are used as LOHC carrier media. Organic oligomers or polymers with extended π-conjugated electron systems, which are transferred into the respective saturated compounds in the loading unit through hydrogenation are possible as LOHC carrier media. The hydrogenation of the hydrogen-unloaded form of the LOHC carrier media takes place in a pressure-stable chemical reactor at a temperature between 50° C. and 400° C., especially between 120° C. and 300° C., in particular, between 150° C. and 280° C. The hydrogenation, that is, the loading of the LOHC carrier medium, takes place with a process pressure of 2 bar to 200 bar, especially at 10 bar to 100 bar and, in particular, in the presence of a metal-containing catalyst.

As catalysts for the loading of the LOHC carrier medium, especially those which comprise the element ruthenium and/or nickel are suitable. Catalysts which comprise other elements or additional elements alongside ruthenium and/or nickel are also possible. Such elements which add hydrogen and can transfer it to LOHC carrier medium are essential. Alongside ruthenium and/or nickel, especially metals such as chromium, iron, cobalt, copper, iridium, palladium or platinum are possible as catalysts. The LOHC carrier medium loaded with hydrogen represents an appropriate transport form and storage form for the chemically bound hydrogen, because the physical-chemical properties of the hydrogen-loaded LOHC carrier medium strongly resemble those of diesel and other fuels.

According to the prior art, an LOHC carrier medium loaded with hydrogen is converted back into the hydrogen-unloaded form at the place and time of the energy demand in an unloading unit with the supply of heat and in the presence of a suitable catalyst, with the release of molecular hydrogen. In the case of the unloading of LOHC carrier materials, the hydrogen is released from an organic molecule or from a mixture of organic molecules through a catalytic dehydrogenation reaction. This means that the release of the hydrogen takes place through a material conversion of the loaded carrier medium through unloading in the unloading unit by means of catalytic dehydrogenation reaction. In the loaded condition, the carrier medium is, in particular, a saturated polycyclic compound, especially a perhydro-dibenzyl toluene or a perhydro-benzyl toluene, which can be used as pure substances, isomer mixtures or mixtures of these. Alternatively, the loaded carrier medium is a saturated polycyclic compound, which contain heteroatoms, such as nitrogen or oxygen, especially perhydro-N-ethylcarbazole, perhydro-N-propylcarbazole, perhydro-N-isopropylcarbazole, perhydro-N-butylcarbazole or mixtures of these substances. Alternatively, a saturated, organic oligomer or polymer, can be used as loaded carrier medium, which can be converted through catalytic dehydrogenation into oligomers or polymers with extended π-conjugated electron systems. The unloading of the loaded carrier medium in the unloading unit takes place, especially in a pressure-stable chemical reactor at a process temperature between 100° C. and 450° C., preferably between 150° C. and 420° C. and, in particular, between 180° C. and 390° C. The process pressure is disposed between 0.1 and 30 bar, especially between 1 and 10 bar, wherein, in particular, a metal-containing catalyst can be used, which contains especially platinum and/or palladium. It is essential that the catalyst is suitable to release hydrogen, which is given off from the LOHC carrier medium, as hydrogen gas. Alongside platinum and/or palladium, metals such as chromium, iron, cobalt, nickel, copper, iridium or ruthenium are especially suitable for this purpose.

As a result of the fact that hydrogen is provided in bound form for material use in order to hydrogenate the material for hydrogenation, the storage and handling of molecular hydrogen is dispensed with. By means of the system according to the invention, the recovery of molecular hydrogen from a hydrogen-loaded carrier medium in a separate process step can be dispensed with. Instead, the liquid, hydrogen-loaded carrier medium is contacted directly with the material for hydrogenation in the transfer-hydrogenation facility. In this context, the hydrogen is transferred from the loaded carrier medium to the material for hydrogenation. The disadvantages associated with the storage and handling of molecular hydrogen are also dispensed with. The use of liquid organic hydride as a carrier medium for the chemical binding of hydrogen has proved particularly advantageous. Such a carrier medium is known per se from EP 1 475 349 A2 and is designated as Liquid Organic Hydrogen Carrier (LOHC). This form of hydrogen storage is known, for example, from the field of handling and especially storage of electrical energy. Surprisingly, it has now been discovered that hydrogen storage by means of a carrier medium, especially by means of LOHC carrier media, especially in liquid form, can be advantageously used for the material use of hydrogen, especially for hydrogenation. By comparison with direct energetic use, for example, in a fuel cell or in a combustion chamber fired with hydrogen, an additional advantage is achieved according to the invention for material use of hydrogen, especially for the hydrogenation of organic or inorganic molecules, in that an unloading of the carrier medium upstream of the material use is not necessary. It is therefore not necessary for the chemically bound hydrogen to be separated from the carrier medium in a separate process step, in order to be further used for the subsequent material use of hydrogen. According to the invention, it was therefore recognized that the hydrogen in the bound form can be used directly for the material use in the transfer-hydrogenation facility. Furthermore, it was found that the advantages resulting from the use of LOHC carrier media can be transferred to the handling and storage of hydrogen for the material use of hydrogen.

A system in which a catalyst is provided in the transfer-hydrogenation unit in order to promote the hydrogenation through a contacting unit for the contacting of the material for hydrogenation with the hydrogen provided in bound form is advantageous. In the transfer-hydrogenation unit, the material for hydrogenation is contacted with the bound hydrogen. In particular, the material for hydrogenation can be present in solid, liquid or gaseous form when it is contacted with the bound hydrogen. The contacting of the material for hydrogenation with the hydrogen provided in bound form therefore takes place in the presence of a catalyst. In particular, a solid catalyst, that is, a heterogeneous catalyst is used for this purpose. Such a catalyst allows the catalysis of the hydrogen release from the loaded liquid organic hydride and/or the hydrogenation of the material for hydrogenation itself In particular, metals which comprise at least one of the elements platinum, palladium, chromium, iron, nickel, cobalt, copper, iridium or ruthenium have proved particularly suitable as catalysts. In this context, it is essential that the catalyst used is suitable to release hydrogen, which is given off from the carrier medium, especially from the LOHC carrier medium, as hydrogen gas, to deposit the released hydrogen gas chemically in the material to be hydrogenated and/or to transfer the hydrogen bound to the surface of the catalyst to the material for hydrogenation. In particular, catalysts which use more than one of the named metals on a carrier material are also possible. Furthermore, it is also possible to use more than one solid catalyst in mixtures for the transfer hydrogenation, wherein at least one of the catalysts used contains at least one of the named metals. A further substantial advantage is that the reaction heat released during the hydrogenation corresponds substantially to the heat to be applied for the release of the hydrogen from the loaded liquid organic hydride. This means that a large reaction heat of the hydrogenation need not be removed from a reactor with effort-intensive cooling devices. Such cooling problems are known from the prior art and—if a cooling is not implemented in an adequate form with effort-intensive cooling devices—lead to an overheating of the material for hydrogenation and of the catalyst. Such overheating can lead, on the one hand, to selectivity problems of the hydrogenation reaction and, on the other hand, to impairments of the operating life of the catalyst used. Furthermore, an uncontrolled overheating can lead to a spontaneous degradation of the material for hydrogenation. Considerable safety-technology problems are generally associated with this. Furthermore, heat need not be provided additionally in order to allow the unloading of the hydrogen-loaded carrier medium. The heat required for this can be drawn, at least to a considerable proportion, from the reaction heat of the hydrogenation process. An effort-intensive cooling or heating of the transfer-hydrogenation unit can be dispensed with.

A system in which the transfer-hydrogenation facility comprises a material separating unit is particularly advantageous. Accordingly, it is possible to implement a hybrid process with the system. Such a hybrid process is used, for example, in the case of an esterification. Alongside the hydrogenation function, the system additionally allows the function of a distillative material separation. The transfer-hydrogenation facility designed in this manner is used as a reactive distillation unit, which serves for the separation of hydrogenated and non-hydrogenated or respectively not-completely hydrogenated components of the material for hydrogenation. Surprisingly, it was found that the liquid organic hydride used as a carrier medium for the hydrogen also has an effect of an extractive solvent or an entrainer within the framework of this reactive distillation, in addition to the hydrogen-donating effect. In this manner, the separation result of hydrogenated and non-hydrogenated or respectively partially hydrogenated components of the material for hydrogenation is improved. For the evaluation of the separation result, it is sufficient if separation factors of hydrogenated and non-hydrogenated or respectively not-completely hydrogenated components of the material for hydrogenation under the influence of the liquid organic hydride are compared. One possible measurement method is known from the prior art as inverse gas chromatography. This measurement method is described in G. Sadowski et al.: Fluid Phase Equilib. 139 (1997), 391 to 403. This investigation was based upon the substance mixture methylcyclohexane-toluene. The separation factor without entrainer is around 1.5. With the named measurement method, it was found that the separation factor can be determined in a temperature-dependent manner under the influence of the un-hydrogenated organic hydride N-ethylcarbazole. With a measurement temperature of 70.76° C., the separation factor is 3.41, with a measurement temperature of 88.64° C., the separation factor is 3.01 and with a measurement temperature of 110.11° C., the separation factor is 2.64. It is therefore advantageous with this embodiment that the separation of methyl cyclohexane from toluene is possible in a shorter substance separating unit by comparison with the absence of extractive rectification effect. In particular, a reduction of the energy consumption is also possible by reducing the reflux ratio. Accordingly, the hybrid process, especially a reactive extractive rectification, can be advantageously implemented.

A system in which the transfer-hydrogenation unit comprises a stirring device is particularly advantageous. In particular, the transfer-hydrogenation unit is constituted as a pressurized container in which the catalyst is intensively contacted by means of the stirring device with the hydrogen-loaded carrier medium, especially the hydrogen-loaded LOHC carrier medium and that material for hydrogenation. Alternatively, the contacting can also be implemented through pump mixing by means of a pump or through fluid inflow by means of an inflow unit. Independently of the choice of contacting, the transfer-hydrogenation unit contains, in particular, a moving suspension, in which the finely distributed, solid catalyst, the liquid carrier medium and the material for hydrogenation are present.

A system in which the hydrogen-provision device comprises a carrier-medium storage unit for the storage of the loaded carrier medium is advantageous. As a result, it is possible to store, that is, to place into intermediate storage, the loaded carrier medium, at an arbitrary time, especially independently of the actual requirement for the loaded carrier medium. With the carry-medium storage unit, the loaded carrier medium can be stored without loss over a considerable period of time. The loaded carrier medium can be released from the carrier-medium storage unit, which is constituted especially as a liquid tank, at a required time, that is, when the material use of the hydrogen is to take place. Appropriate lines and line systems and/or tanker vehicles also serve as a carrier-medium storage unit in the sense of the present patent application. Accordingly, it is possible to load the carrier medium with hydrogen in a hydrogen-provision device by means of a loading unit, wherein the loading can be implemented at a first location. The loaded carrier medium is stored in the carrier-medium storage unit. It is possible to transport the loaded carrier medium, for example, together with the store in the form of a tanker vehicle, from the first location of the loading to a second location at a distance from the first location. The loaded carrier medium can be made available at a second location at which a loading unit is not itself available. In particular, such a transport can also be implemented via a corresponding line network. The availability of loaded carrier medium is therefore additionally improved.

A system in which the hydrogen-provision device comprises a hydrogen-generating unit for the generation of hydrogen is advantageous. In particular, the hydrogen-generating unit serves for the generation of elemental hydrogen. The hydrogen-generating unit is, in particular, an electrolyzer. In the electrolyzer, water is split into hydrogen and oxygen by means of electrolysis. It is particularly advantageous if the electrical current required for the electrolysis has been generated from regenerative energy forms, for example, by means of photovoltaic cells, wind-power generators, geothermal power stations or hydroelectric power stations. The availability of regenerative energy in Central Europe is provided primarily through wind-power stations and solar power stations. These forms of energy are dependent upon meteorological influences and, in particular, cannot be influenced and are predictable only with difficulty. In given regions of the world, regenerative energy forms are available in large volume. The generation of current from regenerative energies is possible in a cost-favorable manner there. This applies, for example, for current generation from geothermal sources in Iceland or for current generation through hydroelectric power in Norway and/or Canada or for current generation through solar power stations in very sun-rich regions of the earth. In order to transport electrical current generated in such a cost-favorable manner from potentially remote locations to the location of the demand for electrical current, a loading unit can additionally be used at the location of the current generation, in order to transport the electrical current in the form of the loaded carrier medium in supply lines and/or transport vehicles to the location of the demand for current, that is, to the electrolyzer for the hydrogen-provision device of the plant according to the invention. For example, a so-called Solid Oxide Electrolysis Cell (SOEC) electrolyzer or a Polymer Electrolyte Membrane (PEM) electrolyzer serves as electrolyzer.

A system with a separating device connected to the transfer-hydrogenation facility is advantageous. In particular, the separating device is connected to a transfer-hydrogenation unit of the transfer-hydrogenation facility. The separating device is used for the separation of a mixture of at least partially unloaded carrier medium and at least partially hydrogenated material for hydrogenation. The separating device can be connected downstream of the transfer-hydrogenation facility. As an alternative, it is possible to integrate the separating device in the transfer-hydrogenation facility, and especially in the transfer-hydrogenation unit, for a reactive distillation. The at least partially dehydrogenated form of the liquid organic hydride separated by means of the separating device is preferably pumped into a store, especially into a storage tank, and stored there. The storage can endure, for example, until an energy-rich period. During an energy-rich period, the unloaded carrier medium can again be loaded, especially with hydrogen generated in a regenerative manner Energy-rich means that more energy, especially electrical current generated from regenerative energy forms, is available than is consumed. This means that there is an energy surplus. The surplus energy can be stored as hydrogen in the carrier medium. However, energy-rich can also mean that energy in the form of electrical current is available at comparatively low costs. By contrast, an energy-poor period is characterized in that energy is not available in sufficient volume or only at high costs. This means that more energy is needed than is available. Alternatively, the at least partially dehydrogenated form of the carrier medium can be transported with a suitable transport means to an energy-rich location. There, the unloaded carrier medium can again be loaded, especially with regeneratively generated hydrogen, in order to be used at a later, especially an energy-poor, time for the material use of the hydrogen.

The embodiment of the separating device as a distillation device is particularly advantageous. Alternatively, the separating device can also be embodied as a liquid-liquid phase separating device or as an extraction device.

A system in which the transfer-hydrogenation unit comprises at least one sensor, especially a temperature sensor and/or a pressure sensor, for the monitoring of at least one process parameter, is advantageous. For example, the reaction temperature in the transfer-hydrogenation unit or the internal pressure in the transfer-hydrogenation unit serve as process parameter. In particular, the at least one sensor is in signal connection with a display unit, in order to display the at least one monitored process parameter. An operator of the plant can act on the process dependent upon the displayed process parameter and, especially, vary the process conditions in such a manner that specified limit values are observed. For example, it is therefore possible to influence the rate of the transfer hydrogenation and especially to control it according to a specification. Especially in the case of a use of temperature-sensitive material for hydrogenation, it is necessary to limit the reaction temperature in the transfer-hydrogenation unit. In this manner it is possible to prevent a thermally induced degradation of the material for hydrogenation.

A system with a control unit for the control of at least one process parameter, especially during the transfer hydrogenation in the transfer-hydrogenation unit is advantageous, wherein the control unit is disposed in a signal connection with at least one sensor, especially a temperature sensor and/or a pressure sensor, for monitoring the at least one process parameter. The signal connection can be provided in tethered or wireless manner. In particular, it is conceivable that the control unit is arranged in a decentralized manner, and especially at a distance from the plant. For example, a control unit can be arranged in a central monitoring facility which is arranged over several kilometers and especially over several hundred kilometers away from the plant, in particular from the transfer-hydrogenation unit. The process parameters detected by means of the at least one sensor are communicated to the control unit and serve as input parameters for a control of the process conditions. The control unit comprises a controller which generates required actuation signals which can be communicated via corresponding signal connections to various components of the plant. For this purpose, the control unit is disposed in signal connection, for example, with a current source, that is, a device for generating electrical current, especially from regenerative energy forms, with the electrolyzer, with the loading unit and/or with the carrier-medium storage unit. In particular, the connection with the carrier-medium storage unit serves for the controlled supply of loaded carrier medium into the transfer-hydrogenation unit. In order to prevent an undesired overheating of the material for hydrogenation, the transfer-hydrogenation unit can be connected to a cooling unit, for example, in the form of heat exchanger. In this case, the control unit is in signal connection with the cooling unit, in order to cause a targeted removal of heat from the transfer-hydrogenation unit.

A system in which the hydrogen-provision device is arranged in an energy-rich location and the transfer-hydrogenation facility is arranged in an energy-poor location different from the energy-rich location is advantageous. In particular, such a system allows the targeted exploitation of specific site advantages. Accordingly, a site in which electrical current can be generated, especially in a cost-favorable manner from regenerative energy forms, such as geothermal and/or hydroelectric energy, is understood as an energy-rich location. For example, such energy-rich sites are Iceland or Canada. At the energy-rich location, the electrical current generated from the regenerative energy forms is used for electrolysis, in order to generate hydrogen and for the hydrogenation of a carrier medium, at the energy-rich location. This means that the loading of the carrier medium with hydrogen takes place by means of the loading unit at the energy-rich location. As a result of the fact that the hydrogen-loaded carrier medium can be transported and/or stored in a particularly uncomplicated manner, it is possible to transport the bound hydrogen in a correspondingly advantageous manner from the energy-rich location to the energy-poor location, especially in tanker vehicles overland and/or by ship. The bound hydrogen can be converted with the material for hydrogenation directly in the transfer-hydrogenation facility. In particular, it is conceivable that the material for hydrogenation is isolated from the unloaded carrier medium after the completed hydrogenation, so that the at least partially dehydrogenated carrier medium can be transported back from the energy-poor location, at which the hydrogenation of the material for hydrogenation takes place, to the energy-rich location of the hydrogen production.

A system with a transport unit for the transportation of the hydrogen provided by means of the hydrogen-provision device in bound form from the energy-rich location to the transfer-hydrogenation facility at the energy-poor location is particularly advantageous. For example, tanker vehicles, such as ships, trains or heavy-goods vehicles are understood as transport means. A pipeline by means of which the loaded carrier medium can be transported directly from the energy-rich location to the energy-poor location is also understood as a transport means.

Precisely because of the considerable transport advantages of carrier-medium bound hydrogen by comparison with the transport of molecular hydrogen, the loading unit for the loading of the carrier medium with hydrogen of the hydrogen-provision device of the system can also be disposed spatially remote from the transfer-hydrogenation facility of the system. The loading unit is advantageously disposed where electricity originating from regenerative energy sources can be favorably converted into hydrogen. The transfer-hydrogenation facility of the system is provided especially where the infrastructure, for example, of a large chemicals plant, allows the manufacture, storage and further processing of the material for hydrogenation in a particularly appropriate manner. The transport route between the loading unit and the transfer-hydrogenation unit can be, for example, several thousand kilometers, for example, if a global shipping of the hydrogen-loaded carrier medium precedes the transfer hydrogenation. Alternatively, a pipeline connection or a transport by road and/or rail may be more appropriate in order to bring the liquid, hydrogen-loaded carrier medium from the loading unit to the transfer-hydrogenation unit.

The method according to the invention for the material use of hydrogen is characterized primarily in that the hydrogen is provided in bound form by means of a hydrogen-provision device in the form of a liquid hydrogen-loaded carrier medium. The binding of the hydrogen to the carrier medium takes place according to the invention in an upstream loading step by means of a loading unit. The hydrogen, especially chemically bound in this manner, can be used for the hydrogenation of a material for hydrogenation by means of a transfer-hydrogenation unit of a transfer-hydrogenation facility. In particular, it is therefore not necessary for the hydrogen to be stored and/or handled in elemental form. Furthermore, an additional method step of unloading a carrier medium loaded with hydrogen is not necessary, because the hydrogen can be used directly for the hydrogenation in the bound form on the carrier medium.

The method according to the invention can be used for the hydrogenation of different materials for hydrogenation in the chemicals and petrochemicals industry, but also in other industries which use hydrogenation reactions. With the system according to the invention, organic or inorganic chemical compounds can be used as materials for hydrogenation. During the transfer hydrogenation according to the invention, the hydrogen content of the material for hydrogenation is increased, wherein the hydrogen converted in this context is not supplied to the system as molecular hydrogen, but bound to a liquid hydrogen-loaded carrier medium. Through the transfer hydrogenation, a hydrogen-poor form of the material for hydrogenation is converted into a hydrogen-rich form of the material for hydrogenation, wherein the hydrogen-rich form is of greater industrial value. Typical hydrogen-poor forms of suitable materials for hydrogenation are inorganic and organic molecules, which can build new chemical bonds through chemical reaction with hydrogen. Furthermore, all compounds reducible with hydrogen, especially singly and multiply unsaturated organic compounds, such as alkenes, alkines, aromatic compounds, compounds with heteroatom-carbon double bonds, such as carbonyl compounds, organic acids, amides, nitriles, nitro compounds, CO, CO₂ and N₂ are suitable materials for hydrogenation. A further class of preferred materials for hydrogenation are heteroatom-containing organic compounds, in which the heteroatom is released from the organic compound through reaction with hydrogen. These are, for example, organic sulphur compounds which, on contact with hydrogen, form hydrogen sulphide and a compound which is present in a desulphured form by comparison with the starting compound. Such materials for hydrogenation which do not exceed a boiling point of 360° C. under normal pressure in hydrogenated form are particularly preferred.

A method in which a contacting of the material for hydrogenation with the hydrogen provided in bound form is provided in the transfer-hydrogenation unit is particularly advantageous. The contacting takes place in the presence of, especially, a solid catalyst. It is particularly advantageous if the hydrogen-poor form of the material for hydrogenation is contacted with the completely loaded form of the liquid carrier medium in the presence of the solid catalyst in the transfer-hydrogenation unit. With a method of this kind, the mean dwell time of the material for hydrogenation in the transfer-hydrogenation facility is between 30 s and 3000 min, and in particular, between 10 min and 600 min. Suitable process temperatures at which all reaction processes of the transfer hydrogenation can occur simultaneously, are disposed in the range between 100° C. and 600° C., especially between 250° C. and 500° C., and, in particular, between 300° C. and 450° C. During the reaction, an increased internal pressure is established in the reactor, especially in the transfer-hydrogenation unit. The value of the internal pressure depends substantially upon the boiling point of the material for hydrogenation. In particular, the internal pressure contains the partial pressure on the hydrogen, which is obtained in a temperature-dependent manner and dependent upon the mechanism of the transfer hydrogenation in the transfer-hydrogenation unit.

A method in which a control of at least one process parameter takes place by means of a control unit, especially during the hydrogenation in the transfer-hydrogenation unit, is particularly advantageous. The control comprises especially a monitoring of the at least one process parameter by means of at least one sensor disposed in signal connection with the control unit. In particular, a temperature sensor and/or a pressure sensor serves for this purpose.

A method in which a separation of a mixture of at least partially unloaded carrier medium and at least partially hydrogenated material for hydrogenation takes place by means of a separating device connected with the transfer-hydrogenation facility is particularly advantageous. In this manner, it is possible to make the products of the method effectively available for a further treatment. For example, the at least partially unloaded carrier medium can be supplied for a new loading with hydrogen. The hydrogenated material for hydrogenation is further processed according to a provided process.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a system according to the invention for the material use of hydrogen.

### DESCRIPTION OF THE PREFERRED EMBODIMENTS

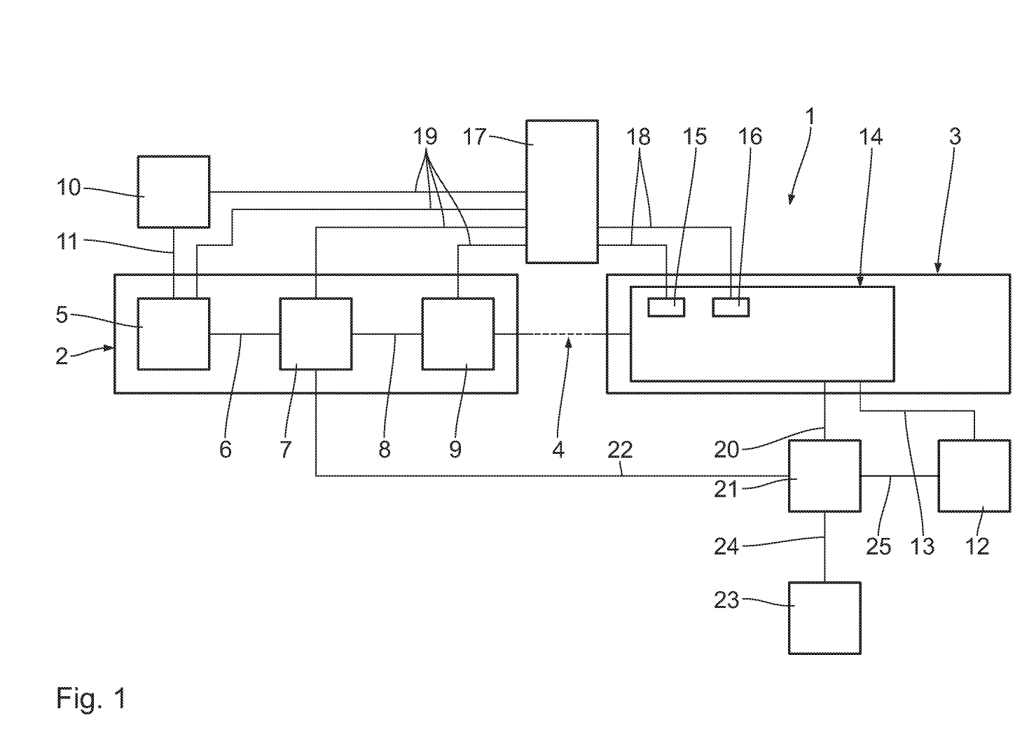

A system illustrated schematically in FIG. 1 and designated as a whole with 1 serves for the material use of hydrogen, especially for hydrogenation. The system 1 comprises a hydrogen-provision device 2, which is connected to a transfer-hydrogenation facility 3 via a transport means 4. According to the illustrated exemplary embodiment, the transport means 4 is formed by a liquid tank, which can be transported, for example, by means of a ship. According to the illustrated exemplary embodiment, the hydrogen-provision device 2 is arranged at an energy-rich location. The transfer-hydrogenation facility 3 is arranged at an energy-poor location remote from the energy-rich location. The distance between the energy-poor and the energy-rich location can be several thousand kilometers.

The hydrogen-provision device 2 comprises a hydrogen-generating unit in the form of an electrolyzer 5 for the generation of hydrogen, especially of elemental hydrogen. The electrolyzer 5 is connected via a hydrogen line 6 to a loading unit 7. The loading unit 7 is part of the hydrogen-provision device 2. The loading unit 7 serves for the loading of a carrier medium with hydrogen which has been generated in the electrolyzer 5 from water. The loading unit 7 is connected via a carrier-medium line 8 to a carrier-medium storage unit in the form of a tank 9. The tank 9 serves for the storage of loaded carrier medium. The transport medium 4 is connected to the tank 9 via a liquid line. By means of the liquid line, loaded carrier medium can be pumped from the hydrogen-provision device 2, especially from the tank 9, into the transport medium 4 and accordingly to the transfer-hydrogenation facility 3. It is also conceivable that the tank 9 is not provided. In this case, the liquid line is connected directly to the carrier-medium line 8.

A current generating device 10 is connected to the hydrogen-provision device 2. The current generating device 10 serves for the generation of electrical current, which is required especially for the electrolysis in the electrolyzer 5. For this purpose, the current generating device 10 is connected via a current line 11 to the electrolyzer 5. The current generating device 10 can be a device which can generate electrical current from regenerative forms of energy. A current generating device 10 can also be a power transmission network, that is, especially a public power transmission network. Third parties can feed current into the power transmission network and remove it as required.

The transfer-hydrogenation facility 3 comprises a transfer-hydrogenation unit 14 which serves for the hydrogenation of a material for hydrogenation, especially toluene. The material for hydrogenation to be hydrogenated is stored, for example, in a hydrogenation-material store 12 which is disposed in fluid connection with the transfer-hydrogenation unit 14 via a hydrogenation-material supply line 13. The material for hydrogenation to be hydrogenated is supplied to the transfer-hydrogenation unit 14 via the hydrogenation-material supply line 13.

A temperature sensor 15 for detecting the process temperature and a pressure sensor 16 for detecting an internal pressure are provided in the transfer-hydrogenation unit 14. It is conceivable that further sensors, especially of the same type, are provided, for example, at different measurement locations within the transfer-hydrogenation unit 14 in order to minimize measurement errors. It is also conceivable that further sensors are provided to detect additional process parameters. In order to display the detected process parameters, that is, the process temperature and the process pressure, a display unit, not illustrated, can be provided, which is connected directly to the sensors 15, 16. According to the illustrated exemplary embodiment, the sensors 15, 16 are in bidirectional signal connection with a control unit 17 via signal lines 18. The control unit 17 is in bidirectional signal connection with components of the system 1, in each case via further signal lines 19. In particular, the control unit 17 is connected directly to the tank 9, to the loading unit 7, to the electrolyzer 5 and/or to the current generating device 10, in each case via a separate signal line 19.

A separating device 21 is connected to the transfer-hydrogenation facility 3 via a liquid line 20. The separating device 21 is used for the separation of a mixture of at least partially unloaded carrier medium and at least partially hydrogenated material for hydrogenation. The separating device 21 is connected via a carrier-medium line 22 to the loading unit 7. This means that at least partially unloaded carrier medium can be pumped back from the separating device 21 via the carrier-medium line 22 for the new loading in the loading unit 7. Alternatively, or additionally, a storage unit for the storage of the at least partially unloaded carrier medium can be provided, for example, along the carrier-medium line 22. It is also possible to transport the partially unloaded carrier medium from the separating device 21 by means of suitable transport means to a further location. In this case, the carrier-medium line 22 can be dispensed with.

For the removal of the at least partially hydrogenated material for hydrogenation from the separating device 21, a hydrogenation-material storage container 23 is provided, which is connected via a hydrogenation-material line 24 to the separating device 21. The hydrogenated material for hydrogenation is stored in the hydrogenation-material storage container 23. Un-hydrogenated material for hydrogenation can be separated in the separating device 21 and fed back via a hydrogenation-material feedback line 25 to the hydrogenation-material store 12.

In the following, the method for material use of hydrogen is explained in greater detail with reference to a first embodiment. The system 1 according to the invention serves for the catalytic transfer hydrogenation. As material for hydrogenation, 0.65 mol toluene is used, and 0.325 mol perhydro-mono-benzyl toluene is used as hydrogen source. The material for hydrogenation and the hydrogen source in the form of the carrier medium are contacted in each case with 0.000325 mol of a ruthenium catalyst supported on aluminum oxide and 0.000325 mol of a platinum catalyst supported on carbon. This mixture is heated for 24 hours at 240° C. In this context, an internal pressure develops in the reactor to which the partial pressure of the material for hydrogenation and a partial pressure of released hydrogen contributes. Under these conditions, the contribution of the hydrogen partial pressure is more than 3 bar. After the end of the reaction, the reactor contents are cooled, and the liquid products are analyzed by means of gas chromatography. The composition of the liquid products results in a degree of hydrogenation of the toluene of 10.4% and a degree of dehydrogenation of the carrier medium of 23.8%.

In the case of a method according to the invention according to a second embodiment, the material for hydrogenation, the carrier medium and the catalysts used are used in an identical manner to the first embodiment. The mixture generated in this manner is heated for a comparatively short period of 45 minutes to a higher temperature of 300° C. The pressure adjusted in this method, especially the contribution of the hydrogen partial pressure, is more than 5 bar under the named conditions. The composition of the liquid products results in a degree of hydrogenation of the toluene of 40.8% and a degree of dehydrogenation of the carrier medium of 53.8%.

The method according to the invention according to a third exemplary embodiment is based on the identical starting materials according to the first exemplary embodiment. By comparison with the first exemplary embodiment, the heating duration is only 30 minutes. The heating temperature is 350° C. The contribution of the hydrogen partial pressure is more than 5 bar. The composition of the liquid products results in a degree of hydrogenation of the toluene of 95.5% and a degree of dehydrogenation of the carrier medium of 99.2%.

While specific embodiments of the invention have been shown and described in detail to illustrate the application of the principles of the invention, it will be understood that the invention may be embodied otherwise without departing from such principles.

1. A system for a material use of hydrogen comprising:
a transfer-hydrogenation facility comprising a transfer-hydrogenation unit for hydrogenation of a material for hydrogenation;
a hydrogen-provision device for provision of hydrogen for the transfer-hydrogenation facility, wherein, by means of the hydrogen-provision device, hydrogen is provided in bound form for the transfer-hydrogenation facility, and the hydrogen-provision device comprises a loading unit for loading a carrier medium with hydrogen.

2. A system according to claim 1, wherein a catalyst is provided in the transfer-hydrogenation unit in order to promote the hydrogenation by contacting the material for hydrogenation with the hydrogen provided in bound form.

3. A system according to claim 2, wherein the transfer-hydrogenation unit comprises a stirring device, wherein the catalyst is present as a suspension of a finely distributed, solid catalyst in a mixture of liquid carrier medium and material for hydrogenation.

4. A system according to claim 1, wherein the hydrogen-provision device comprises a carrier-medium storage unit for storage of loaded carrier medium.

5. A system according to claim 1, wherein the hydrogen-provision device comprises a hydrogen-generating unit for generating hydrogen.

6. A system according to claim 1, further comprising:
a separating device connected with the transfer-hydrogenation facility for separation of a mixture of at least partially unloaded carrier medium and at least partially hydrogenated material for hydrogenation.

7. A system according to claim 8, wherein the separating device is constituted as a distillation device.

8. A system according to claim 1, wherein the transfer-hydrogenation unit comprises at least one sensor for monitoring at least one process parameter.

9. A system according to claim 1, further comprising:
a control unit for controlling at least one process parameter, wherein the control unit is disposed in a signal connection with at least one sensor for monitoring the at least one process parameter.

10. A system according to claim 1, wherein the hydrogen-provision device is arranged in an energy-rich location, and the transfer-hydrogenation facility is arranged in an energy-poor location different from the energy-rich location.

11. A system according to claim 10, further comprising:
a transport unit transporting the hydrogen provided by means of the hydrogen-provision device in bound form from the energy-rich location to the transfer-hydrogenation facility at the energy-poor location.

12. A method for a material use of hydrogen comprising the method steps:
loading a carrier medium with hydrogen by means of a loading unit;
provisioning the hydrogen bound to the carrier medium by means of hydrogen-provision device;
hydrogenating a material for hydrogenation by means of a transfer-hydrogenation unit of a transfer-hydrogenation facility with use of the hydrogen provided in bound form.

13. A method according to claim 12, further comprising:
contacting the material for hydrogenation with the hydrogen provided in bound form in a presence of a catalyst in the transfer-hydrogenation unit.

14. A method according to claim 12, further comprising:
controlling at least one process parameter by means of a control unit.

15. A method according to claim 12, further comprising:
separating a mixture of at least partially unloaded carrier medium and at least partially hydrogenated material for hydrogenation by means of a separating device connected with the transfer-hydrogenation facility.

16. A system according to claim 1, wherein the hydrogen-provision device comprises a hydrogen-generating unit for generating elemental hydrogen.

17. A system according to claim 8, wherein the sensor is at least one of a temperature sensor and a pressure sensor.

18. A system according to claim 9, wherein the at least one process parameter comprises a control during the hydrogenation in the transfer-hydrogenation unit.

19. A system according to claim 9, wherein the control unit is disposed in a signal connection with at least one of a temperature sensor and a pressure sensor.

20. A method according to claim 14, wherein the at least one process parameter comprises a control during the hydrogenation in the transfer-hydrogenation unit.

21. A method according to claim 14, wherein the step of controlling comprises monitoring the at least one process parameter by means of at least one sensor disposed in signal connection with the control unit.

22. A method according to claim 14, wherein the at least one sensor is in signal connection with at least one of a temperature sensor and a pressure sensor.
